(19) United States
(12) Patent Application Publication
(10) Pub. No.: US 2023/0387541 A1
(43) Pub. Date: Nov. 30, 2023

(54) SEALED BATTERY

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Tsuyoshi EHARA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Shigeru MATSUMOTO, Toyohashi-shi (JP); Yasuaki NAGANO, Kosai-shi (JP)

(21) Appl. No.: 18/303,568

(22) Filed: Apr. 20, 2023

(30) Foreign Application Priority Data
May 26, 2022 (JP) 2022-086252

(51) Int. Cl. H01M 50/325; H01M 50/159; H01M 50/103; H01M 50/15

(52) U.S. Cl. CPC H01M 50/325; H01M 50/159; H01M 50/103; H01M 50/15

(57) ABSTRACT

In a sealed battery, a battery case includes a metal wall portion formed with a gas vent hole. Of an outer surface of the metal wall portion, a hole-surrounding annular surface surrounding an opening edge of the gas vent hole includes an annular seal surface surrounding the opening edge of the gas vent hole. A resin safety valve member covering and closing the the gas vent hole includes an annular joined portion hermetically joined to the annular seal surface. The annular joined portion of the resin safety valve breaks when the internal pressure of the battery case reaches a valve opening pressure, thereby opening the resin safety valve member.

### CROSS-REFERENCE TO RELATED APPLICATIONS

This application is based upon and claims the benefit of priority to a Japanese Patent Application No. 2022-086252 filed on May 26, 2022, the entire contents of which are incorporated herein by reference.

### BACKGROUND

### Technical Field

The present disclosure relates to a sealed battery.

### Related Art

Japanese unexamined patent application publication No. 2018-041668 discloses a sealed battery including an electrode body, and a metal battery case accommodating the electrode body. The battery case is provided with a rectangular box-shaped case body having an opening, and a metal lid member closing the opening of the case body. The case body and the lid member are integrated together by welding, constituting the battery case. The lid member is provided, at its center, with a safety valve. This safety valve is integrated with the lid member.

The safety valve is thinner than other portions of the lid member and formed with a groove portion on the top surface. Thus, the safety valve actuates when the internal pressure of the battery case reaches a predetermined pressure (i.e., a pressure at which the safety valve opens, hereinafter referred to as a valve opening pressure). Specifically, when the internal pressure of the battery case reaches the valve opening pressure, the groove portion ruptures to open the safety valve, thus releasing gas out of the battery case. This configuration can prevent the internal pressure of the battery case from excessively rising, i.e., from reaching a dangerous internal pressure.

### SUMMARY

### Technical Problems

Meanwhile, the foregoing safety valve is integrated together with the lid member made of aluminum. To be concrete, the safety valve is formed in the lid member at the same time of press-molding the lid member from an aluminum plate. However, a method for forming a safety valve in a lid member by the press-molding has limitations on the thickness and the material of a metal plate to be molded into the lid member. This method is therefore difficult to address a wide variety of sealed batteries.

From those circumstances, it has been required to make a safety valve from a different member from a metal wall portion, such as a lid member, that makes up a battery case. Specifically, it has been required that the battery case is formed as a battery case having a metal wall portion formed with a gas vent hole, the safety valve is formed as a safety valve member that closes the gas vent hole by covering an annular (ring-shaped) hole-surrounding surface, which is a part of the metal wall portion and surrounds an opening of the gas vent hole, and the gas vent hole is appropriately sealed with the safety valve member. Furthermore, a safety valve member made of resin is demanded for easy production. In other words, a sealed battery has been required in which the gas vent hole formed in the metal wall portion of the battery case is sealed with a resin safety valve member made of resin, and this resin safety valve member opens when the internal pressure of the battery case reaches the valve opening pressure.

The present disclosure has been made to address the above problems and has a purpose to provide a sealed battery in which a gas vent hole formed in a metal wall portion of a battery case is sealed with a resin safety valve member made of resin, which can open when the internal pressure of the battery case reaches a valve opening pressure.

### Means of Solving the Problems

(1) To achieve the above-mentioned purpose, one aspect of the present disclosure provides a sealed battery comprising: a battery case including a metal wall portion formed with a gas vent hole, the metal wall portion having an outer surface including a hole-surrounding surface having an annular shape surrounding an opening edge of the gas vent hole; and a safety valve member closing the gas vent hole by covering the hole-surrounding surface, wherein the safety valve member is a resin safety valve member made of resin, the hole-surrounding surface includes an annular seal surface that surrounds the opening edge of the gas vent hole, the resin safety valve member includes an annular joined portion hermetically joined to the annular seal surface, and the annular joined portion is configured to break to open the resin safety valve member when an internal pressure of the battery case reaches a valve opening pressure.

The foregoing sealed battery includes the safety valve member that closes the gas vent hole by covering the hole-surrounding annular surface, which is a part of the outer surface of the metal wall portion of the battery case and surrounds the opening edge of the gas vent hole. The safety valve member is a resin safety valve member made of resin. This resin safety valve member includes the annular joined portion hermetically joined to the annular seal surface (included in the hole-surrounding surface) surrounding the opening edge of the gas vent hole. With this annular joined portion, the resin safety valve member is hermetically joined to the metal wall portion, and hence the gas vent hole is sealed with the resin safety valve member.

In this sealed battery, moreover, when the internal pressure of the battery case reaches the valve opening pressure, the annular joined portion of the resin safety valve member breaks, or ruptures, thus opening the resin safety valve member, that is, releasing the sealing of the gas vent hole sealed with the resin safety valve member. To be concrete, when the internal pressure of the battery case reaches the valve opening pressure, the stress caused in the annular joined portion by the internal pressure of the battery case reaches a breaking strength of the annular joined portion, thereby breaking the annular joined portion and thus releasing the gas vent hole from sealing by the resin safety valve member. Accordingly, the inside of the battery case is maintained hermetic with the annular joined portion of the resin safety valve member hermetically joined to the annular seal surface of the metal wall portion, whereas once the internal pressure of the battery case reaches the valve opening pressure, the resin safety valve member opens, releasing the gas out of the battery case to prevent the internal pressure of the battery case from excessively rising.

As described above, the foregoing sealed battery is a sealed battery in which the gas vent hole formed in the metal wall portion of the battery case is sealed with the resin safety valve member made of resin and further the resin safety valve member opens when the internal pressure of the battery case reaches the valve opening pressure.

(2) In the sealed battery described in (1), furthermore, the annular seal surface is an annular roughened surface having an uneven shape with pits and protrusions, and the resin safety valve member is hermetically joined to the annular roughened surface by the annular joined portion made of part of the resin forming the safety valve member, the part of the resin forming the annular joined portion entering into the pits of the annular roughened surface.

In the foregoing sealed battery, the annular joined portion of the resin safety valve member is hermetically joined to the annular roughened surface having an uneven shape with pits and projections by entering or penetrating of the resin that forms the annular joined portion into the pits of the annular roughened surface of the metal wall portion. In other words, the annular joined portion of the resin safety valve member is hermetically joined to the annular roughened surface by the anchor effect exerted by biting of the protrusions of the annular roughened surface of the metal wall portion into the annular joined portion of the resin safety valve member. This can enhance the hermeticity between the annular joined portion of the resin safety valve member and the annular roughened surface of the metal wall portion and hence increase the hermeticity of the sealed battery.

(3) In the sealed battery described in (1) or (2), furthermore, the battery case comprises: a case body having an opening; and a metal lid closing the opening of the case body, and the metal lid includes the metal wall portion.

In the foregoing sealed battery, the metal lid includes the metal wall portion. Specifically, in the battery case, the metal lid closing the opening of the battery case is formed with the gas vent hole, and a portion of the outer surface of the metal lid, surrounding the opening edge of the gas vent hole, is the annular seal surface. In the above-described sealed battery, therefore, the resin safety valve member is provided on the metal lid in the form that the annular joined portion of the resin safety valve member is hermetically joined to the annular seal surface of the metal lid.

(4) In the sealed battery described in (3), furthermore, the metal lid and the resin safety valve member may be integrated together by insert molding.

In this sealed battery, the metal lid and the resin safety valve member are integrated together by insert molding. Specifically, the resin safety valve member is made of resin by injection molding with the metal lid set as an insert member, so that the metal lid and the resin safety valve member are integrally molded. In other words, the metal lid and the resin safety valve member constitute an insert molded product produced by integral molding of the metal lid and the resin safety valve member. Using such the insert molded product of the metal lid and the resin safety valve member integrally molded by insert molding, the sealed battery with the gas vent hole formed in the metal lid and sealed with the resin safety valve member can be easily and appropriately produced.

(5) In the sealed battery described in any one of (1) to (4), furthermore, the annular joined portion of the resin safety valve member may include a minimum-width joined portion as a part in a circumferential direction of the annular joined portion, the minimum-width joined portion being configured to be smaller in width than other portions of the annular joined portion in plan view and to break when the internal pressure of the battery case reaches the valve opening pressure to open the resin safety valve member.

The smaller the width of the annular joined portion of the resin safety valve member, the more easily the annular joined portion breaks. Herein, the width of the annular joined portion is a distance between the inner perimeter and the outer perimeter of the annular joined portion in plan view. Accordingly, in the annular joined portion including the minimum-width joined portion as a smaller part in width than other portions in the circumferential direction, the minimum-width joined portion can most easily break compared to the other portions. Since this minimum-width joined portion is provided as a part of the annular joined portion in the circumferential direction, a valve opening position, where the annular joined portion is to break when the internal pressure of the battery case reaches the valve opening pressure, can be set at the minimum-width joined portion. This configuration can set the valve opening pressure with high accuracy. The thus configured sealed battery is a sealed battery with accurately set valve opening pressure.

(6) In the sealed battery described in any one of (1) to (4), furthermore, the annular joined portion may have an elliptical annular shape or oblong annular shape in plan view.

For the annular joined portion having an elliptical or oblong annular shape, when the pressing force acts on the resin safety valve member due to a rise in the internal pressure of the battery case, the stress concentrates on a portion located on the minor axis of an ellipse or oblong circle defining the outer perimeter of the annular joined portion, referred to as an on-minor-axis portion. This on-minor-axis portion of the annular joined portion more easily breaks than other portions. Since the annular joined portion is thus designed with an elliptical annular shape or an oblong annular shape in plan view, a valve opening position, where the annular joined portion is to break when the internal pressure of the battery case reaches the valve opening pressure, can be set at the on-minor-axis portion. This configuration can set the valve opening pressure with high accuracy. The thus configured sealed battery is a sealed battery with an accurately set valve opening pressure. The oblong circular shape has two parallel straight sides and a semicircle with both ends connected to each one end of the two straight sides and a semicircle with both ends connected to each the other end of the two straight sides, such as a race-track shape.

(7) In the sealed battery described in (5), furthermore, the annular joined portion may have an elliptical annular shape or an oblong annular shape in plan view, including the minimum-width joined portion located on the minor axis of the ellipse or oblong circle defining the outer perimeter of the annular joined portion.

Since the annular joined portion having an elliptical annular shape or oblong annular shape in plan view is provided with the minimum-width joined portion on the minor axis on which the stress concentrates when the pressing force acts on the resin safety valve member due to a rise in the internal pressure of the battery case, the valve opening position, where the annular joined portion is to break when the internal pressure of the battery case reaches the valve opening pressure, can be set at the minimum-width joined portion. This configuration can set the valve opening pressure with high accuracy. The thus configured sealed battery is a sealed battery with an accurately set valve opening pressure.

### BRIEF DESCRIPTION OF THE DRAWINGS

FIG. 1 is a plan view, i.e., a top view, of a sealed battery in an embodiment;

FIG. 2 is a front view of the sealed battery;

FIG. 3 is a cross-sectional view taken along B-B in FIG. 1;

FIG. 4 is an enlarged view of a section C in FIG. 3 and a section G in FIG. 6;

FIG. 5 is a plan view of a safety valve-equipped lid, i.e., an insert molded product;

FIG. 6 is a cross-sectional view taken along D-D in FIG. 5;

FIG. 7 is a plan view of a metal lid;

FIG. 8 is a cross-sectional view taken along E-E in FIG. 7; and

FIG. 9 is an enlarged view of a section F in FIG. 8.

### DETAILED DESCRIPTION OF THE EXEMPLARY EMBODIMENTS

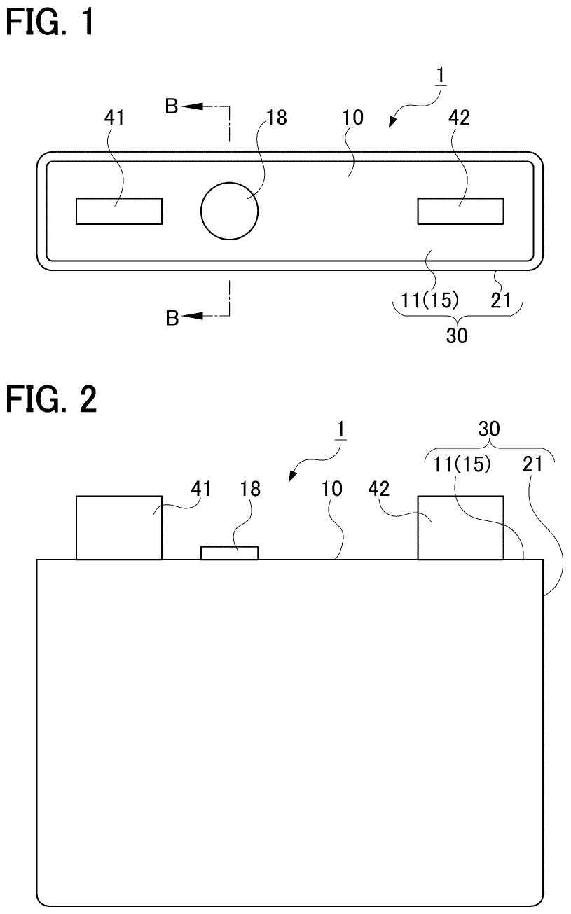

A detailed description of an embodiment of this disclosure will now be given referring to the accompanying drawings. A sealed battery 1 in the present embodiment is a lithium-ion secondary battery and includes a battery case 30, an electrode body 50 accommodated in the battery case 30, a positive terminal 41, and a negative terminal 42 (see FIGS. 1 to 3). The battery case 30 is a hard case made of metal and has a rectangular parallelepiped box-like shape. This battery case 30 includes a metal case body 21 having a rectangular tubular shape with a closed bottom, and a metal lid 11 having a rectangular flat plate shape and closing an opening 21b of the case body 21 (see FIGS. 1 to 3). The metal lid 11 includes a metal wall portion 15 formed with a gas vent hole 12. This metal wall portion 15 is a part of the metal lid 11.

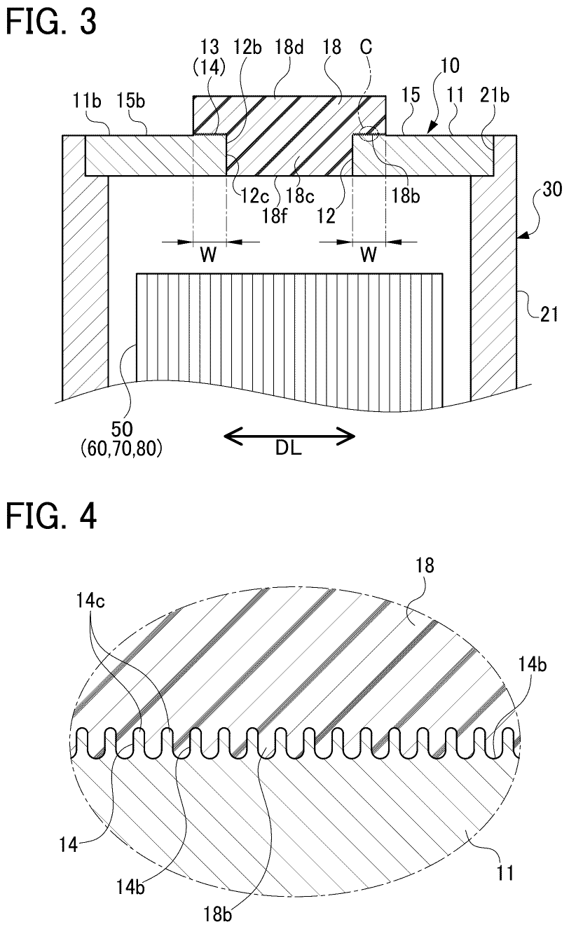

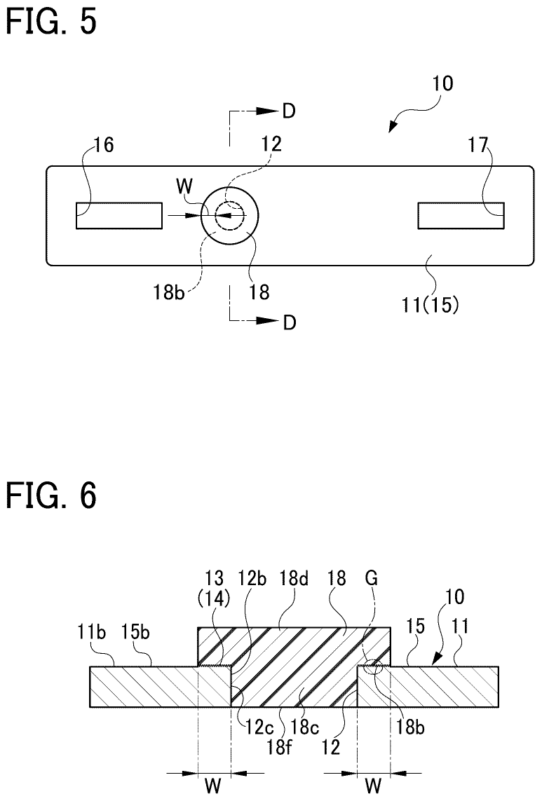

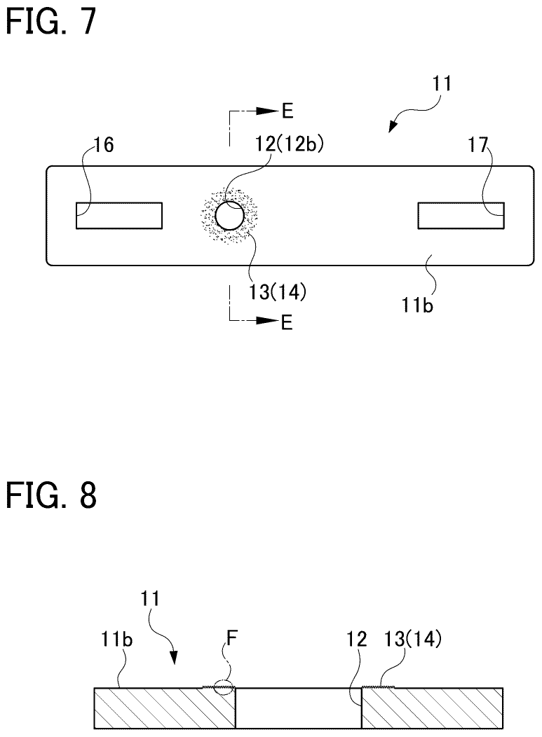

The metal lid 11 has two through holes 16 and 17 each having a rectangular tubular shape as shown in FIGS. 5 and 7. The positive terminal 41 is inserted through the through hole 16, while the negative terminal 42 is inserted through the through hole 17, as shown in FIGS. 1 and 2. In addition, a tubular insulation member (not shown) is interposed between the inner peripheral surface of the through hole 16 of the metal lid 11 and the outer peripheral surface of the positive terminal 41 and another tubular insulation member (not shown) is interposed between the inner peripheral surface of the through hole 17 of the metal lid 11 and the outer peripheral surface of the negative terminal 42. The metal lid 11, concretely, the metal wall portion 15, is formed with the gas vent hole 12 having a cylindrical shape penetrating through the metal lid 11 in its thickness direction as shown in FIG. 3.

The electrode body 50 includes positive electrode sheets 60, negative electrode sheets 70, and separators 80 each interposed between the positive electrode sheet 60 and the negative electrode sheet 70. More concretely, the electrode body 50 is a lamination electrode body provided with a plurality of positive electrode sheets a plurality of negative electrode sheets 70, and a plurality of separators 80, in which the positive electrode sheets 60 and the negative electrode sheets 70 are alternately laminated, or stacked, with the separators 80 each interposed therebetween in a lamination direction DL as shown in FIG. 3. The electrode body 50 further contains an electrolytic solution not shown. This electrolytic solution, not shown, is also accommodated within the battery case 30 on the bottom side. The positive electrode sheets 60 of the electrode body 50 are connected to the positive terminal 41 through a positive current collecting tab (not shown). The negative electrode sheets are connected to the negative terminal 45 through a negative current collecting tab (not shown).

Furthermore, the sealed battery 1 is provided with a resin safety valve member 18 for closing the gas vent hole 12 by covering a hole-surrounding surface 13 having a circular annular shape surrounding an opening edge 12b of the gas vent hole 12, the hole-surrounding surface 13 being a part of an outer surface 11b of the metal lid 11 (concretely, an outer surface 15b of the metal wall portion 15), as shown in FIGS. 1 to 3. The resin safety valve member 18 has a circular plate-like shape, including a first portion 18c of a circular plate-like shape located inside the gas vent hole 12 and a second portion 18d of a circular plate-like shape having a larger diameter than the first portion 18c and contacting the hole-surrounding surface 13 of the metal lid 11 as shown in FIG. 3. The resin safety valve member 18 may be made of a resin with low permeability to an electrolytic solution, for example, polyphenylene sulfide (PPS), polyarylene sulfide (PAS), olefin resin, or fluororesin. In the present embodiment, the resin safety valve member 18 is made of PPS.

The hole-surrounding surface 13 of the metal lid 11 includes an annular seal surface 14 having a circular annular shape surrounding the opening edge 12b of the gas vent hole 12 as shown in FIGS. 7 to 9. The second portion 18d of the resin safety valve member 18 includes an annular joined portion 18b hermetically joined to the annular seal surface 14 as shown in FIGS. 3 and 4. The annular joined portion 18b has a circular annular shape in plan view. With the annular joined portion 18b configured as above, the resin safety valve member 18 is hermetically joined to the metal lid 11, concretely, the metal wall portion 15, and the gas vent hole 12 is sealed with the resin safety valve member 18. It is noted that the first portion 18c of the resin safety valve member 18 is not hermetically joined to the inner peripheral surface 12c of the gas vent hole 12, so that gas is allowed to enter between the first portion 18c and the inner peripheral surface 12c.

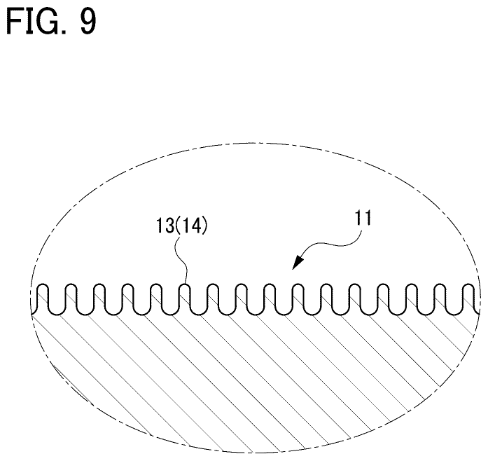

In the present embodiment, especially, the annular seal surface 14 of the metal lid 11 (concretely, the metal wall portion 15) is an annular roughened surface 14 having an uneven shape with pits 14b and protrusions 14c as shown in FIGS. 8 and 9. This annular roughened surface 14 has a circular annular, or circular ring, shape in plan view as shown in FIG. 7. The resin safety valve member 18 is hermetically joined to the annular roughened surface 14 by the annular joined portion 18b, which is made of part of the resin forming the resin safety valve member 18, the part of the resin forming the annular joined portion entering, or penetrating, into the pits 14b of the annular roughened surface 14, as shown in FIG. 4. In other words, the annular joined portion 18b of the resin safety valve member 18 is hermetically joined to the annular roughened surface 14 by the anchor effect exerted by biting of the protrusions 14c of the annular roughened surface 14 of the metal wall portion 15 into the annular joined portion 18b of the resin safety valve member 18. This can enhance the hermeticity between the annular joined portion 18b of the resin safety valve member 18 and the annular roughened surface 14 of the metal wall portion 15, and hence increase the hermeticity of the sealed battery 1.

The annular roughened surface 14 can be formed by a well-known surface roughening treatment applied to the hole-surrounding surface 13 of the outer surface 11b of the metal lid 11. This treatment may include for example a laser surface treatment, a sandblasting treatment, and an anodizing treatment. One example of the laser surface treatment is disclosed in Japanese unexamined patent application publication No. 2022-028587. In the present embodiment, the hole-surrounding surface 13 of the metal lid 11 is roughened by the the laser surface treatment to form the annular roughened surface 14.

The metal lid 11 and the resin safety valve member 18 are integrated by insert molding. Specifically, the metal lid 11 and the resin safety valve member 18 are insert-molded to form a lid 10 equipped with a safety valve, hereinafter referred to as a safety valve-equipped lid 10, which is an insert molded product including the metal lid 11 integrated with the resin safety valve member 18 as shown in FIGS. 5 and 6. This safety valve-equipped lid 10 is produced as below. Specifically, the metal lid 11 with the annular roughened surface 14 (see FIGS. 7 to 9) is prepared first. Subsequently, with this metal lid 11 set as an insert member, the resin safety valve member 18 is made of resin by injection molding. The safety valve-equipped lid 10 is thus produced as the insert molded product in which the metal lid 11 and the resin safety valve member 18 are integrated together, as shown in FIGS. 5 and 6.

By use of the safety valve-equipped lid 10 including the metal lid 11 and the resin safety valve member 18 integrated together by insert molding, the sealed battery 1 can be easily and appropriately manufactured with the gas vent hole 12 of the metal lid 11 sealed with the resin safety valve member 18. It is noted that a part of the resin injected to mold the resin safety valve member 18, that is, a resin forming the annular joined portion 18b, enters into the pits 14b of the annular roughened surface 14 of the metal lid 11, so that the annular joined portion 18b of the resin safety valve member 18 is hermetically joined to the annular roughened surface 14 of the metal lid 11 as shown in FIG. 4.

In the sealed battery 1, moreover, when the internal pressure of the battery case 30 reaches the valve opening pressure, the annular joined portion 18b of the resin safety valve member 18 breaks, e.g., cleaves, to open the resin safety valve member 18, i.e., release the sealing of the gas vent hole 12 sealed with the resin safety valve member 18. More specifically, when the internal pressure of the battery case 30 rises due to the generation of gas in the battery case 30, the force that pushes upward a lower surface 18g of the resin safety valve member 18 (concretely, the lower surface 18g of the first portion 18c) becomes larger, and thus the stress occurring in the annular joined portion 18b becomes larger (see FIG. 3). When the internal pressure of the battery case 30 then reaches the valve opening pressure, the stress generated in the annular joined portion 18b reaches the breaking strength of the annular joined portion 18b. At this time, the annular joined portion 18b breaks, releasing the gas vent hole 12 from sealing by the resin safety valve member 18. For example, when a part of the annular joined portion 18b in the circumferential direction breaks, a gas vent channel is formed thereat in the annular joined portion 18b. This gas vent channel allows the gas in the battery case 30 to escape to the outside through the gas vent hole 12, thereby preventing an excessive rise of the internal pressure of the battery case 30.

As described above, the sealed battery 1 in the present embodiment is configured such that the annular joined portion 18b of the resin safety valve member 18 is hermetically joined to the annular seal surface 14 of the metal lid 11 (concretely, of the metal wall portion 15) to maintain the hermeticity of the battery case 30, whereas once the internal pressure of the battery case 30 reaches the valve opening pressure, the resin safety valve member 18 opens to release the gas out of the battery case 30 in order to prevent the internal pressure of the battery case 30 from excessively rising. Thus, the sealed battery 1 is achieved as a sealed battery in which the gas vent hole 12 of the metal wall portion 15 of the battery case 30 is sealed with the resin safety valve member 18, and further the resin safety valve member 18 opens when the internal pressure of the battery case 30 reaches the valve opening pressure.

In the present embodiment, the valve opening pressure of the resin safety valve member 18 is determined by the minimum width W of the annular joined portion 18b of the resin safety valve member 18. Herein, the width of the annular joined portion 18b is the distance between the inner perimeter and the outer perimeter of the annular joined portion 18b in plan view, which may be referred to as a “seal length”. The minimum width W of the annular joined portion 18b is the shortest distance between the inner perimeter and the outer perimeter of the annular joined portion 18b in plan view, as shown in FIGS. 3 and 5, which may be referred to as a “minimum seal length”. In the present embodiment, the annular joined portion 18b is of a circular annular shape, or a circular ring shape, in plan view and the inner perimeter and the outer perimeter of the annular joined portion 18b are concentric. Thus, the width of the annular joined portion 18b is constant over the entire circumference, and the width of the annular joined portion 18b is considered as the minimum width W.

The valve opening pressure of the resin safety valve member 18 corresponds to the internal pressure of the battery case 30 at which the annular joined portion 18b of the resin safety valve member 18 is broken to release the gas vent hole 12 from sealing by the resin safety valve member 18. Thus, the greater the minimum width W of the annular joined portion 18b of the resin safety valve member 18 is set, the more difficult it becomes to break the annular joined portion 18b to unseal the gas vent hole 12. This causes a larger valve opening pressure.

TABLE 1

| Minimum width W (mm) | Valve opening pressure (MPa) |
|---|---|
| 0.3 | 0.6 |
| 0.5 | 1.4 |
| 0.7 | 2.1 |
| 0.9 | 3.0 |
| 1.1 | 4.1 |
| 1.3 | 6.5 |

Table 1 shows the correspondence relationship between the minimum width W (mm) and the valve opening pressure (MPa) of the annular joined portion 18b. For example, as shown in Table 1, for a sealed battery 1 with the annular joined portion 18b having a minimum width W of 0.5 mm, the valve opening pressure can be set to 1.4 MPa. For another sealed battery 1 with the annular joined portion 18b having a minimum width W of 0.9 mm, the valve opening pressure can be set to 3.0 MPa. In this way, the valve opening pressure of the resin safety valve member 18 can be determined by the minimum width W of the annular joined portion 18b of the resin safety valve member 18.

The present disclosure is described in the above embodiment, but is not limited thereto. It should be understood that the present disclosure may be embodied in other specific forms without departing from the essential characteristics thereof.

For example, the above-described embodiment adopts the safety valve-equipped lid 10 provided with the metal lid 11 and the resin safety valve member 18 integrated together by insert molding. However, the safety valve-equipped lid 10 may be a safety valve-equipped lid provided with the metal lid 11 and a resin safety valve member made of a resin film welded to the metal lid 11. This safety valve-equipped lid can be produced as below. Specifically, the metal lid 11 with the annular roughened surface 14 (see FIGS. 7 to 9) is prepared first. The resin safety valve member formed of a resin film is further prepared. Then, the metal lid 11 is heated to 200° C. and further a part of the surface of the resin safety valve member, which will contact with the annular roughened surface 14, is heated to soften or fuse, and finally the resin safety valve member is welded to the annular roughened surface 14 of the metal lid 11. At that time, a part of the resin that forms the resin safety valve member, i.e., the resin that forms the annular joined portion, enters into the pits 14b of the annular roughened surface 14 of the metal lid 11, enabling hermetic joining between the annular joined portion of the resin safety valve member and the annular roughened surface 14 of the metal lid 11.

In the foregoing embodiment, the annular joined portion 18b of the resin safety valve member 18 has the circular annular shape in plan view with a uniform width in the circumferential direction. As another alternative, however, the annular joined portion may include a minimum-width joined portion as a part of the annular joined portion in the circumferential direction, the minimum-width joined portion being smaller in width than other portions of the annular joined portion in plan view. In this annular joined portion, the width of the minimum-width joined portion is the minimum width W of the annular joined portion. For the sealed battery including such an annular joined portion, accordingly, when the internal pressure of the battery case reaches the valve opening pressure, the minimum-width joined portion breaks, opening the resin safety valve member. This is because the minimum-width joined portion is a most breakable part of the annular joined portion. Since this minimum-width joined portion is provided as a part of the annular joined portion in the circumferential direction, a valve opening position, where the annular joined portion is to break when the internal pressure of the battery case reaches the valve opening pressure, can be set at the minimum-width joined portion. This configuration enables accurate setting of the valve opening pressure. The sealed battery including this annular joined portion can therefore be achieved as a sealed battery with the accurately set valve opening pressure.

In the present embodiment, the annular joined portion 18b of the resin safety valve member 18 is designed with an exact circular ring shape in plan view, but alternatively it may be of an elliptical annular shape or an oblong annular shape in plan view. In this case, the gas vent hole and the annular roughened surface also may be of the elliptical annular shape or the oblong annular shape in plan view equivalent or similar to the shape of the annular joined portion. For the annular joined portion having an elliptical annular shape or an oblong annular shape in plan view, when the pressing force acts on the resin safety valve member due to a rise in the internal pressure of the battery case, the stress concentrates on a portion located on the minor axis of an ellipse or oblong circle defining the outer perimeter of the annular joined portion, referred to as an on-minor-axis portion. This on-minor-axis portion of the annular joined portion thus breaks more easily than other portions. Since the annular joined portion is thus designed with an elliptical annular shape or an oblong annular shape in plan view, a valve opening position, where the annular joined portion is to break when the internal pressure of the battery case reaches the valve opening pressure, can be set at the on-minor-axis portion. This configuration can set the valve opening pressure with high accuracy. The sealed battery including this annular joined portion is therefore a sealed battery with an accurately set valve opening pressure. The oblong circle has two parallel straight sides and a semicircle with both ends connected to each one end of the two straight sides and a semicircle with both ends connected to each the other end of the two straight sides, such as a race-track shape.

Furthermore, the annular joined portion of the resin safety valve member may be of an elliptical annular shape or oblong annular shape in plan view, including the minimum-width joined portion located on the minor axis of an ellipse or oblong circle defining the outer perimeter of the annular joined portion. Since the annular joined portion having an elliptical annular shape or oblong annular shape in plan view is provided with the minimum-width joined portion on the minor axis on which the stress concentrates when the pressing force acts on the resin safety valve member due to an increase in internal pressure of the battery case, the valve opening position, where the annular joined portion is to break when the internal pressure of the battery case reaches the valve opening pressure, can be set at the minimum-width joined portion. This configuration can set the valve opening pressure with high accuracy. This sealed battery including the thus configured annular joined portion is a sealed battery with accurately set valve opening pressure.

The forgoing embodiment exemplifies the sealed battery 1 in which the gas vent hole 12 is formed in the metal wall portion 15 of the metal lid 11 and the resin safety valve member 18 closes this gas vent hole 12. As another alternative, however, the present disclosure also includes a sealed battery in which a gas vent hole is formed in a metal wall portion of the case body 21 and a resin safety valve member closes this gas vent hole.

### REFERENCE SIGNS LIST

1 Sealed battery
11 Metal lid
11b Outer surface
12 Gas vent hole
12b Opening edge (of gas vent hole)
13 Hole-surrounding surface
14 Annular roughened surface (Annular seal surface)
14b Pit
15 Metal wall portion
15b Outer surface (of metal wall portion)
18 Resin safety valve member (Safety valve member)
18b Annular joined portion
21 Case body
30 Battery case

What is claimed is:

1. A sealed battery comprising:
a battery case including a metal wall portion formed with a gas vent hole, the metal wall portion having an outer surface including a hole-surrounding surface having an annular shape surrounding an opening edge of the gas vent hole; and
a safety valve member closing the gas vent hole by covering the hole-surrounding surface,
wherein
the safety valve member is a resin safety valve member made of resin,
the hole-surrounding surface includes an annular seal surface that surrounds the opening edge of the gas vent hole,
the resin safety valve member includes an annular joined portion hermetically joined to the annular seal surface, and
the annular joined portion is configured to break to open the resin safety valve member when an internal pressure of the battery case reaches a valve opening pressure.

2. The sealed battery according to claim 1, wherein
the annular seal surface is an annular roughened surface having an uneven shape with pits and protrusions, and
the resin safety valve member is hermetically joined to the annular roughened surface by the annular joined portion made of part of the resin forming the safety valve member, the part of the resin forming the annular joined portion entering into the pits of the annular roughened surface.

3. The sealed battery according to claim 1, wherein
the battery case comprises:
a case body having an opening; and
a metal lid closing the opening of the case body, and
the metal lid includes the metal wall portion.

4. The sealed battery according to claim 2, wherein
the battery case comprises:
a case body having an opening; and
a metal lid closing the opening of the case body, and
the metal lid includes the metal wall portion.
